(19) United States
(12) Patent Application Publication
(10) Pub. No.: US 2005/0220700 A1
(43) Pub. Date: Oct. 6, 2005

(54) Positive electrode active material powder for lithium secondary battery

(75) Inventors: Manabu Suhara, Chigasaki-shi (JP); Takuya Mihara, Chigasaki-shi (JP); Koichiro Ueda, Chigasaki-shi (JP); Yukimitsu Wakasugi, Chigasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Seimi Chemical Co., Ltd., Chigasaki-shi (JP)

(21) Appl. No.: 11/133,322

(22) Filed: May 20, 2005

Related U.S. Application Data
(63) Continuation of application No. PCT/JP04/03295, filed on Mar. 12, 2004.

(30) Foreign Application Priority Data
Mar. 14, 2003 (JP) 2003-70834

(51) Int. Cl. H01M 4/52; H01M 4/50

(52) U.S. Cl. 423/594.4; 429/224; 429/223; 429/231.3

(57) ABSTRACT

A lithium-nickel-cobalt-manganese composite oxide powder for a positive electrode of a lithium secondary battery, which has a large volume capacity density and high safety and is excellent in the charge and discharge cyclic durability, is presented.

It is a lithium-nickel-cobalt-manganese composite oxide powder for a lithium secondary battery, represented by the formula LiₚNiₓCo_{y}Mn_{z}M_{q}O₂₋ₐFₐ (wherein M is a transition metal element other than Ni, Co or Mn, or an alkaline earth metal element, 0.9≦p≦1.1, 0.2≦x≦0.5, 0.1≦y≦0.4, 0.2≦z≦0.5, 0≦q≦0.05, 1.9≦2-a≦2.1, x+y+z+q=1, and 0≦a≦0.02). The lithium-nickel-cobalt-manganese composite oxide is an agglomerated granular composite oxide powder having an average particle size D50 of from 3 to 15 μm, formed by agglomeration of many fine particles, and the compression breaking strength of the powder is at least 50 MPa.

### FIELD OF THE INVENTION

The present invention relates to a lithium-nickel-cobalt-manganese composite oxide powder for a positive electrode of a lithium secondary battery, which has a large volume capacity density and high safety and is excellent in the charge and discharge cyclic durability, a positive electrode for a lithium secondary battery containing the lithium-nickel-cobalt-manganese composite oxide powder, and a lithium secondary battery.

### DISCUSSION OF BACKGROUND

Recently, as the portability and cordless tendency of instruments have progressed, a demand for a non-aqueous electrolyte secondary battery such as a lithium secondary battery which is small in size and light in weight and has a high energy density, has been increasingly high. As a positive electrode active material for the non-aqueous electrolyte secondary battery, a composite oxide of lithium and a transition metal such as LiCoO₂, LiNiO₂, LiNi_{0.8}Co_{0.2}O₂, LiMn₂O₄ or LiMnO₂, has been known.

Among them, a lithium secondary battery using a lithium-cobalt composite oxide (LiCoO₂) as a positive electrode active material and using a lithium alloy or carbon such as graphite or carbon fiber as a negative electrode, can obtain a high voltage at a level of 4V, whereby it has been widely used as a battery having a high energy density.

However, in the case of the non-aqueous type secondary battery using LiCoO₂ as a positive electrode active material, further improvement of the capacity density per unit volume of a positive electrode layer and the safety, has been desired. On the other hand, there has been a problem of deterioration of the cyclic properties such as gradual reduction of the battery discharge capacity due to repetitive charge and discharge cycle, a problem of the weight capacity density or substantial reduction of the discharge capacity at a low temperature.

In order to solve a part of these problems, it has been proposed in JP-A-6-243897 that the average particle size of LiCoO₂ as a positive electrode active material, be from 3 to 9 μm, the volume occupied by a group of particles having a particle size of from 3 to 15 μm, be at least 75% of the total volume, and the intensity ratio of the diffraction peaks at 2θ=about 19° and 45° as measured by means of X-ray diffraction using CuKα as a radiation source, be of a specific value, so that it becomes an active material excellent in the coating properties, the self-discharge properties and the cyclic properties. Further, in the document, it has been proposed that the positive electrode active material is preferably one which does not substantially have such a particle size distribution that the particle size of LiCoO₂ is 1 μm or smaller or 25 μm or larger. With such a positive electrode active material, the coating properties and the cyclic properties have been improved, but, the safety, the volume capacity density and the weight capacity density, have not yet been fully satisfactory.

Further, in order to improve the weight capacity density and the charge and discharge cyclic properties of the positive electrode, JP-A-2000-82466 proposes a positive electrode active material wherein the average particle size of lithium-cobalt composite oxide particles is from 0.1 to 50 μm, and at least two peaks are present in the particle size distribution. Further, it has been proposed to mix two types of positive electrode active materials having different average particle sizes to prepare a positive electrode active material wherein at least two peaks are present in the particle size distribution. In such a proposal, there may be a case where the weight capacity density and the charge and discharge cyclic properties of the positive electrode can be improved, but on the other hand, there is a complication that the positive electrode material powders having two types of particle size distributions have to be produced, and one satisfying all of the volume capacity density, the safety, the coating uniformity, the weight capacity density and the cyclic properties of the positive electrode, has not yet been obtained.

Further, in order to solve the problem related to the battery characteristics, JP-A-3-201368 proposes to replace 5 to 35% of Co atoms with W, Mn, Ta, Ti or Nb to improve the cyclic properties. Further, JP-A-10-312805 proposes to use hexagonal LiCoO₂ as a positive electrode active material to improve the cyclic properties, wherein the c axis length of the lattice constant is at most 14.051 Å, and the crystal lattice size of (110) direction of the crystal lattice is from 45 to 100 nm.

Further, JP-A-2001-80920 proposes a granular lithium composite oxide which is an agglomerated granular lithium composite oxide formed by agglomeration of a fine powder and having the formula LiₓNi_{1-y-z}Co_{y}Me_{z}M_{q}O₂ (wherein 0<x<1.1, 0<y≦0.6 and 0≦z≦0.6) and which has a compression strength of from 0.1 to 1.0 gf per grain. However, such a composite oxide has a problem that it is poor in the safety and is inferior in the large current discharge properties, and further, with such a small range of compression strength, it is impossible to obtain a lithium composite oxide having sufficiently satisfactory characteristics with respect to e.g. the volume capacity density, safety, cycle properties and large electric current discharge properties.

As described above, in the prior art, with respect to a lithium secondary battery employing a lithium composite oxide as a positive electrode active material, it has not yet been possible to obtain one which fully satisfies the volume capacity density, cyclic properties, large current discharge properties, etc. It is an object of the present invention to provide a lithium-nickel-cobalt-manganese composite oxide powder for a positive electrode of a lithium secondary battery, a positive electrode for a lithium secondary battery containing such a lithium-nickel-cobalt-manganese composite oxide powder, and a lithium secondary battery, which satisfy such properties which have been difficult to accomplish by the prior art.

### SUMMARY OF THE INVENTION

The present inventors have conducted an extensive research, and they have paid attention to a relation between the compression breaking strength of an agglomerated granular composite oxide powder having a specific average particle size, formed by agglomeration of many fine particles of lithium-nickel-cobalt-manganese composite oxide having a specific composition for positive electrode of a lithium secondary battery, and the volume capacity density of the positive electrode of a lithium secondary battery employing the powder, and have found that the two have a positive interrelation. Namely, they have found that as the compression breaking strength of the powder is large, the obtainable positive electrode may have a large volume capacity density. Yet, it has been confirmed that such a large volume capacity density of the positive electrode can be accomplished without impairing other properties required for a positive electrode, such as the volume capacity density, safety, cyclic properties and large current discharge properties.

Thus, according to the present invention, by increasing the compression breaking strength of such an agglomerated granular composite oxide powder to a level higher than ever, it is possible to obtain a lithium-nickel-cobalt-manganese composite oxide for a positive electrode of a lithium secondary battery, which has a large volume capacity density and which sufficiently satisfies the properties such as the safety, cyclic properties and large current discharge properties.

The above relation between the compression breaking strength and the volume capacity density of a positive electrode, discovered by the present invention, is a novel technical concept as opposed to the conventional technical concept whereby, as disclosed in JP-A-2001-80920, in order to obtain a high initial discharge capacity or capacity retention per weight, the compression strength of a lithium-cobalt composite oxide powder for a positive electrode of a lithium secondary battery should be controlled within a prescribed range and should not be made larger than the prescribed level.

Thus, the present invention has the following characteristics:

(1) A lithium-nickel-cobalt-manganese composite oxide powder for a lithium secondary battery, characterized in that it is an agglomerated granular composite oxide powder having an average particle size D50 of from 3 to 15 μm, formed by agglomeration of many fine particles of lithium-nickel-cobalt-manganese composite oxide represented by the formula LiₚNiₓCo_{y}Mn_{z}M_{q}O₂₋ₐFₐ (wherein M is a transition metal element other than Ni, Co or Mn, or an alkaline earth metal element, 0.9≦p≦1.1, 0.2≦x≦0.5, 0.1≦y≦0.4, 0.2≦z≦0.5, 0≦q≦0.05, 1.9≦2-a≦2.1, x+y+z+q=1, and 0≦a≦0.02), and the compression breaking strength of the powder is at least 50 MPa.

(2) The lithium-nickel-cobalt-manganese composite oxide powder according to the above (1), wherein the specific surface area of the powder is from 0.3 to 2.0 m²/g, and the shape of particles is substantially spherical.

(3) The lithium-nickel-cobalt-manganese composite oxide powder according to the above (1) or (2), wherein 0.94≦x/z≦1.06, and the contained remaining alkali amount is at most 0.25 wt %.

(4) The lithium-nickel-cobalt-manganese composite oxide powder according to the above (1), (2) or (3), wherein the compression breaking strength of the powder is from 80 to 300 MPa.

(5) A lithium-nickel-cobalt-manganese composite oxide powder for a lithium secondary battery, characterized in that a lithium-nickel-cobalt-manganese composite oxide powder for a lithium secondary battery having a large particle size, which is an agglomerated granular composite oxide powder having an average particle size D50 of from 3 to 15 μm, formed by agglomeration of many fine particles of a lithium-nickel-cobalt-manganese composite oxide represented by the general formula LiₚNiₓCo_{y}Mn_{z}M_{q}O₂₋ₐFₐ (wherein M is a transition metal element other than Ni, Co or Mn, or an alkaline earth metal element, and 0.9≦p≦1.1, 0.2≦x≦0.5, 0.1≦y≦0.4, 0.2≦z≦0.5, 0≦q≦0.05, 1.9≦2-a≦2.1, x+y+z+q=1, and 0≦a≦0.02) wherein the compression breaking strength of the powder is at least 50 MPa, and a lithium-nickel-cobalt-manganese composite oxide powder for a lithium secondary battery having a small particle size, having an average particle size of from ½ to ⅕ of the average particle size D50 of the large particle size, are mixed in a weight ratio of from 9:1 to 6:4.

(6) The lithium-nickel-cobalt-manganese composite oxide powder for a lithium secondary battery according to the above (5), wherein the lithium-nickel-cobalt-manganese composite oxide powder for a lithium secondary battery having a large particle size, wherein the compression breaking strength of the powder is at least 50 MPa, and the lithium-nickel-cobalt-manganese composite oxide powder for a lithium secondary battery having a small particle size, having an average particle size of from ½ to ⅕ of the average particle size D50 of the large particle size, are mixed in a weight ratio of from 8.5:1.5 to 7:3.

(7) The lithium-nickel-cobalt-manganese composite oxide powder for a lithium secondary battery according to the above (5) or (6), wherein the average particle size D50 formed by agglomeration of many fine particles of the lithium-nickel-cobalt-manganese composite oxide, is from 8 to 15 μm.

(8) A positive electrode for a lithium secondary battery containing the lithium-nickel-cobalt-manganese composite oxide as defined in any one of the above (1) to (7).

(9) A lithium secondary battery using the positive electrode as defined in the above (8).

The reason as to why it is possible by the present invention to increase the volume capacity density of a positive electrode by increasing the compression breaking strength of a lithium-nickel-cobalt-manganese composite oxide powder, is not necessarily clearly understood, but may be explained as follows. In a case where a positive electrode is formed by compressing a lithium-nickel-cobalt-manganese composite oxide agglomerate powder, if the compression breaking strength of the powder is high, the compression stress energy during the compression will not be used for breaking the powder, and the compression stress will act on individual powder particles directly, and consequently, high packing due to slippage of particles constituting the powder one another, will be accomplished. On the other hand, if the compression breaking strength of the powder is low, the compression stress energy will be consumed for breaking the powder, and consequently, the pressure exerted to individual particles constituting the powder will decrease, whereby compaction due to slippage of the particles one another tends to hardly take place, and it tends to be difficult to improve the density of the positive electrode.

### DETAILED DESCRIPTION OF THE PREFERRED EMBODIMENTS

The lithium-nickel-cobalt-manganese composite oxide powder for a positive electrode of a lithium secondary battery of the present invention is represented by the formula LiₚNiₓCo_{y}Mn_{z}M_{q}O₂₋ₐFₐ. In the formula, M, p, x, y, z, q and a are as defined above. Particularly, p, q, x, y, z, q and a are preferably as follows. 0.98≦p≦1.05, 0.25≦x≦0.42, 0.25≦y≦0.35, 0.25≦z≦0.42, 0≦q≦0.02, 1.95≦2-a≦2.05, x+y+z+q=1, and 0≦a≦0.01. Here, when a is larger than 0, it is a composite oxide having some of its oxygen atoms substituted by fluorine atoms. In such a case, the safety of the obtained positive electrode active material will be improved.

The lithium-nickel-cobalt-manganese composite oxide powder of the present invention contains Ni and Mn as essential components. As Ni is contained within the numerical value range of x in the above formula, the discharge capacity will be improved. If x is less than 0.2, the discharge capacity tends to be low. On the other hand, if it exceeds 0.5, the safety tends to decrease, such being undesirable. Further, when Mn is contained within the numerical value range of z in the above formula, the safety will be improved. If z is less than 0.2, the safety tends to be inadequate. On the other hand, if it exceeds 0.5, the discharge capacity tends to be low, or the large current discharge properties tend to be low, such being undesirable.

Further, M is a transition metal element other than Ni, Co or Mn, or an alkaline earth metal. The transition metal element represents a transition metal of Group 4, Group 5, Group 6, Group 7, Group 8, Group 9, Group 10 and Group 11 of the Periodic Table. Among them, M is preferably at least one element selected from the group consisting of Ti, Zr, Hf, V, Nb, Ta, Mg, Ca, Sr, Ba and Al. Among them, Ti, Zr, Hf, Mg or Al is preferred from the viewpoint of the higher capacity, the safety, the cyclic durability, etc.

In the present invention, in a case where the above element M and/or F is contained, each of M and F is preferably present on the surface of the lithium-nickel-cobalt-manganese composite oxide particles. If it is present in the interior of the particles, not only the effect of improving the battery characteristics tends to be small, but also the battery characteristics may decrease in some cases. By the presence of these elements on the surface, the important battery characteristics such as the safety or the charge and discharge cyclic properties can be improved by an addition of a small amount without bringing about the reduction of the battery performance. The presence of M and F on the surface can be judged by carrying out a spectroscopic analysis such as a XPS analysis with respect to the positive electrode particles.

The lithium-nickel-cobalt-manganese composite oxide of the present invention is required to be a granular powder formed by agglomeration of many fine particles represented by the above formula. Such fine particles are not particularly limited, but their average particle size D50 (hereinafter referred to also as a volume average particle size) is preferably from 0.5 to 7 μm. And, the average particle size D50 of the composite oxide powder formed by agglomeration of many such fine particles is preferably from 3 to 15 μm, more preferably from 5 to 12 μm. If the average particle size of the composite oxide powder is smaller than 3 μm, it tends to be difficult to form a dense electrode layer. On the other hand, if it is larger than 15 μm, the large current discharge properties tend to decrease, such being undesirable.

Further, the powder of the agglomerated granular composite oxide of the present invention is required to have a compression breaking strength (hereinafter may be referred to simply as a compression strength) of at least 50 MPa. Such a compression strength (St) is a value obtained by the formula of Hiramatsu et al. (“Journal of the Mining and Metallurgical Institute of Japan”, Vol. 81, No. 932, December 1965, p. 1024-1030) shown by the following formula 1.
St=2.8P/nd² (d: particle size, P: load exerted to particle) Formula 1

If the above compression strength of the agglomerated granular composite oxide particle is smaller than 50 MPa, it tends to be difficult to form a dense electrode layer, and the electrode density tends to decrease, whereby the above-mentioned object of the present invention can hardly be accomplished. Particularly preferably, the compression strength is from 80 to 300 MPa.

Further, the lithium-nickel-cobalt-manganese composite oxide of the present invention is preferably such that the specific surface area is preferably from 0.3 to 2.0 m²/g, particularly preferably from 0.4 to 1.0 m²/g, and the shape of particles is preferably substantially spherical, i.e. spherical or oval. When the lithium-nickel-cobalt-manganese composite oxide satisfies such characteristics, the effects for e.g. the high capacity, the high cyclic durability and the high safety, can be accomplished. Further, in the lithium-nickel-cobalt-manganese composite oxide of the present invention, it is preferred that 0.94≦x/z≦1.06, and the contained remaining alkali amount is at most 0.25 wt %, particularly preferably at most 0.15 wt %. When 0.94≦x/z≦1.06, a high capacity and high cyclic durability can be obtained, and when the remaining alkali amount is at most 0.25 wt %, deterioration of the battery during high temperature storage can be reduced.

The present invention further provides a lithium-nickel-cobalt-manganese composite oxide powder for a lithium secondary battery, characterized in that a lithium-nickel-cobalt-manganese composite oxide powder for a lithium secondary battery having a large particle size, which is an agglomerated granular composite oxide powder having an average particle size D50 of from 3 to 15 μm, preferably from 8 to 15 μm, formed by agglomeration of many fine particles of a lithium-nickel-cobalt-manganese composite oxide represented by the general formula LiₚNiₓCo_{y}Mn_{z}M_{q}O₂₋ₐFₐ wherein the compression breaking strength of the powder is at least 50 MPa, and a lithium-nickel-cobalt-manganese composite oxide powder for a lithium secondary battery having a small particle size, having an average particle size of from ½ to ⅕ of the average particle size D50 of the large particle size, are mixed in a weight ratio of from 9:1 to 6:4. By mixing the lithium-nickel-cobalt-manganese composite oxide powder having a large size and the lithium-nickel-cobalt-manganese composite oxide powder having a small size as described above in the weight ratio within the above range, particularly preferably in a weight ratio of from 8.5:1.5 to 7:3, the density of the electrode can be further improved.

The lithium-nickel-cobalt-manganese composite oxide of the present invention is formed by firing a mixture comprising a lithium source, a nickel source, a cobalt source, a manganese source, and an element M source and a fluorine source to be used as the case requires, at from 700 to 1,050° C.

As the lithium source, lithium carbonate or lithium hydroxide may, for example, be used. However, it is particularly preferred to use lithium carbonate. When lithium carbonate is used as the lithium source, the cost will be low as compared, for example, with a case where lithium hydroxide is used, and an inexpensive high performance lithium-nickel-cobalt-manganese composite oxide desired in the present invention can easily be obtained, such being preferred. Further, as the nickel, cobalt and manganese sources, a nickel-cobalt-manganese composite oxyhydroxide may, for example, be employed. On the other hand, as the material for element M to be used as the case requires, a hydroxide, an oxide, a carbonate or a fluoride may preferably be selected for use. As the fluorine source, a metal fluoride, LiF or MgF₂ may, for example, be selected for use.

If the above firing temperature is lower than 700° C., lithium-modification tends to be incomplete. On the other hand, if it exceeds 1,050° C., the charge and discharge cyclic durability and the initial capacity tend to be low. The firing temperature is particularly preferably from 900 to 1,000° C. The firing is preferably carried out in multi-stages. As a preferred example, a case may be mentioned wherein firing is carried out at 700° C. for a few hours, followed by firing at a temperature of from 900 to 1,000° C. for a few hours.

A powder mixture comprising a lithium source, a nickel source, a cobalt source, a manganese source and an element M source and a fluorine source to be used as the case requires, is subjected to firing treatment at a temperature of from 700 to 1,050° C. as mentioned above, in an oxygen-containing atmosphere for from 5 to 20 hours, and the obtained fired product is cooled, then pulverized and classified, to obtain an agglomerated granular composite oxide powder formed by agglomeration of fine particles of lithium-nickel-cobalt-manganese composite oxide of preferably from 0.3 to 7 μm. In such a case, it is possible to control the compression strength and the average particle size of the agglomerated granular composite oxide powder to be formed, by selecting the nature of the raw materials such as the cobalt source, or the conditions such as the firing temperature, firing time, etc. for lithium-modification.

In a case where a positive electrode of a lithium secondary battery is produced from such a lithium-nickel-cobalt-manganese composite oxide, a binder material and a carbon type electroconductive material such as acetylene black, graphite or ketjenblack, may be mixed to the powder of such a composite oxide. As such a binder material, polyvinylidene fluoride, polytetrafluoroethylene, polyamide, carboxymethyl cellulose or an acrylic acid may, for example, be preferably employed.

The powder of the lithium-nickel-cobalt-manganese composite oxide of the present invention, the conductive material and the binding material are formed into a slurry or a kneaded product by using a solvent or a dispersion medium, which is supported on a positive electrode current collector such as aluminum foil or stainless steel foil by e.g. coating to form a positive electrode for a lithium secondary battery.

In a lithium secondary battery using the lithium-nickel-cobalt-manganese composite oxide of the present invention as the positive electrode active material, a porous polyethylene or a porous propylene film may be used as the separator. Further, as a solvent of the electrolyte solution of the battery, various solvents may be used. However, a carbonate ester is preferred. As the carbonate ester, each of a cyclic type and a chain type can be used. As the cyclic carbonate ester, propylene carbonate or ethylene carbonate (EC) may, for example, be mentioned. As the chain carbonate ester, dimethyl carbonate, diethyl carbonate (DEC), ethyl methyl carbonate (EMC), methyl propyl carbonate or methyl isopropyl carbonate may, for example, be mentioned.

In the present invention, the carbonate ester may be used alone or by mixing at least two types. Further, it may be used by mixing with another solvent. Further, according to the material of the negative electrode active material, if the chain carbonate ester is used together with the cyclic carbonate ester, there is a case where the discharge properties, the cyclic durability or the charge and discharge efficiency can be improved.

Further, in the lithium secondary battery using the lithium-nickel-cobalt-manganese composite oxide of the present invention as the positive electrode active material, a gel polymer electrolyte containing a vinylidene fluoride-hexafluoropropylene copolymer (for example, KYNAR manufactured by ELF Atochem) or a vinylidene fluoride-perfluoropropyl vinyl ether copolymer may be employed. As the solute to be added to the electrolyte solvent or the polymer electrolyte, at least one member of lithium salts is preferably used, wherein e.g. ClO₄—, CF₃SO₃—, BF₄—, PF₆—, AsF₆—, SbF₆—, CF₃CO₂— or (CF₃SO₂)₂N— is anion. It is preferably added at a concentration of from 0.2 to 2.0 mol/L (liter) to the electrolyte solvent or the polymer electrolyte comprising the lithium salt. If the concentration departs from this range, ionic conductivity will decrease, and the electrical conductivity of the electrolyte will decrease. More preferably, it is from 0.5 to 1.5 mol/L.

In the lithium battery using the lithium-nickel-cobalt-manganese composite oxide of the present invention as the positive electrode active material, as the negative electrode active material, a material which can occlude and discharge lithium ions may be used. The material forming the negative electrode active material is not particularly limited, however, lithium metal, a lithium alloy, a carbon material, an oxide comprising, as a main body, a metal of Group 14 or Group 15 of the Periodic Table, a carbon compound, a silicon carbide compound, a silicone oxide compound, titanium sulfide or a boron carbide compound may, for example, be mentioned. As the carbon material, an organic material which is subjected to thermal decomposition under various thermal decomposition conditions, artificial graphite, natural graphite, soil graphite, exfoliated graphite or squamation graphite etc. can be used. Further, as the oxide, a compound comprising tin oxide as a main body can be used. As the negative electrode current collector, a copper foil, a nickel foil etc. can be used. The negative electrode is produced preferably by kneading the active material with an organic solvent to form a slurry, which is coated on the metal foil current collector, dried and pressed.

The shape of the lithium battery using the lithium-cobalt composite oxide of the present invention as the positive electrode active material is not particularly limited. Sheet, film, folding, winding type cylinder with bottom or button shape etc. is selected according to use.

### EXAMPLES

Now, the present invention will be explained in further detail with reference to Examples. However, the present invention is by no means restricted to such specific Examples.

In the Examples, the X-ray diffraction analyses were carried out by using RINT-2000 model, manufactured by Rigaku Corporation under the conditions of a CuKα tube, a tube voltage of 40 KV, a tube current of 40 mA, a light-receiving slit of 0.15 mm and a sampling width of 0.02°. In the present invention, for the particle size analysis, Microtrac HRA X-100 model, manufactured by Leed+Northrup, was used.

### Example 1

Into a reactor, an aqueous sulfate solution containing nickel sulfate, cobalt sulfate and manganese sulfate, aqueous ammonia and an aqueous sodium hydroxide solution were, respectively, continuously supplied, while stirring the interior of the reactor, so that the pH of the slurry in the reactor became 11, and the temperature became 50° C. The amount of the liquid in the reaction system was adjusted by an overflow system, and the coprecipitation slurry over-flown was subjected to filtration, washing with water and then drying at 70° C. to obtain a nickel-cobalt-manganese complex hydroxide powder. The obtained hydroxide was dispersed in a 6 wt % sodium persulfate aqueous solution containing 3 wt % of sodium hydroxide, followed by stirring at 20° C. for 12 hours to obtain a nickel-cobalt-manganese composite oxyhydroxide.

To this composite oxyhydroxide powder, a lithium carbonate powder having an average particle size of 20 μm was mixed, followed by firing in the atmosphere at 900° C. for 16 hours, and then by mixing and pulverization to obtain a LiNi_{1/3}Co_{1/3}Mn_{1/3}O₂ powder. Further, this positive electrode powder had a specific surface area of 0.58 m²/g by a nitrogen adsorption method and a volume average particle size D50 of 11.5 μm. The powder X-ray diffraction spectrum using CuKα-ray was analogous to a rhombohedral system (R-3m). By the SEM observation, the positive electrode powder particles were found to be ones having numerous primary particles agglomerated to form secondary particles, and their shapes were spherical or oval. With respect to the obtained LiNi_{1/3}Co_{1/3}Mn_{1/3}O₂ powder, the compression strength was measured by using a microcompression tester MCT-W500, manufactured by Shimadzu Corporation. Namely, with respect to optional ten particles having known particle sizes, the measurement was carried out by using a flat surface type indenter having a diameter of 50 μm with a test load of 100 mN at a loading rate of 3.874 mN/sec, whereby the compression strength was 142 MPa. Further, 10 g of this LiNi_{1/3}Co_{1/3}Mn_{1/3}O₂ powder was dispersed in 100 g of pure water, and after filtration, the remaining alkali amount was obtained by measuring the potential difference with 0.02 N HCl and found to be 0.12 wt %.

This positive electrode powder, acetylene black, graphite powder and a PVDF binder were mixed in a solid content weight ratio of 88/3/3/6, and an N-methyl pyrrolidone solvent was added, followed by mixing by a ball mill to obtain a coating slurry. This slurry was applied on one side of an aluminum foil current collector having a thickness of 20 μm, by a doctor blade system, and the solvent was removed by hot air drying, followed by roll pressing four times to obtain a positive electrode sheet. The apparent density of the electrode layer was obtained from the thickness of the electrode layer of the positive electrode and the weight of the electrode layer per unit area and found to be 3.14 g/cc.

Using this positive electrode sheet as a positive electrode, using a porous polypropylene having a thickness of 25 μm as a separator, using a metal lithium foil having a thickness of 500 μm as a negative electrode, using a nickel foil of 20 μm as a negative electrode current collector and using 1M LiPF₆/EC+DEC (1:1) as an electrolyte, a simplifying sealed cell type lithium battery made of stainless steel was assembled in an argon globe box. This battery was firstly charged by CC-CV up to 4.3 V at a load current of 20 mA per 1 g of the positive electrode active material at 25° C., and discharged down to 2.5 V at a load current of 20 mA per 1 g of the positive electrode active material, whereby the initial discharge capacity was obtained. Further, the charge and discharge cycle test was carried out 30 times.

As a result, the initial weight discharge capacity density at a voltage of from 2.5 to 4.3 V at 25° C. was 161 mAh/g, the initial volume discharge capacity density was 444 mAh/CC-electrode layer, the initial charge and discharge efficiency was 89%, and the capacity retention after 30 times of charge and discharge cycle was 97.0%.

### Example 2

A nickel-cobalt-manganese composite oxyhydroxide (Ni/Co/Mn atomic ratio: 1/1/1) was obtained in the same manner as in Example 1 except that the stirring rate of the coprecipitation slurry and the slurry concentration were increased. The particle size distribution of this composite oxide was measured by a laser scattering method. As a result, the volume average particle size D50 was 8.7 μm.

A lithium carbonate powder was mixed to this composite oxyhydroxide powder, and the mixture was fired in the same manner as in Example 1, followed by mixing and pulverization to obtain a LiNi_{1/3}Co_{1/3}Mn_{1/3}O₂ powder. This positive electrode power had a specific surface area of 0.70 m²/g by a nitrogen adsorption method and a volume average particle size D50 of 9.4 μm. Further, the powder X-ray diffraction spectrum using a Cu—Kα-ray was analogous to a rhombohedral system (R-3m). In the same manner as in Example 1, the breaking strength of the particles was obtained and found to be 114 MPa. Further, the remaining alkali amount of this positive electrode powder was obtained in the same manner as in Example 1 and found to be 0.13 wt %.

Using this positive electrode powder, a positive electrode sheet was prepared in the same manner as in Example 1. The electrode layer density of the obtained positive electrode sheet was 3.13 g/cc. Using this positive electrode sheet as a positive electrode, a simple sealed cell made of stainless steel was assembled, and the charge and discharge performance was evaluated, in the same manner as in Example 1. As a result, the initial weight discharge capacity density at 25° C. was 160 mAh/g, the initial volume discharge capacity density was 441 mAh/CC-electrode layer, and the initial charge and discharge efficiency was 91.0%. Further, the capacity retention after 30 times of charge and discharge cycle was 97.3%.

### Example 3

A nickel-cobalt-manganese composite oxyhydroxide (Ni/Co/Mn atomic ratio: 0.38/0.24/0.38) was obtained in the same manner as in Example 1 except that the compositional ratio of the aqueous sulfate solution containing nickel sulfate, cobalt sulfate and manganese sulfate was changed. By the SEM observation, the composite oxyhydroxide powder particles were found to be ones having numerous primary particles agglomerated to form secondary particles, and their shape was spherical or oval. To such a composite oxyhydroxide powder, a lithium carbonate powder was mixed, and in the same manner as in Example 1, a LiNi_{0.38}Co_{0.24}Mn_{0.38}O₂ powder was obtained. This positive electrode power had a specific surface area of 0.63 m²/g by a nitrogen adsorption method and a volume average particle size D50 of 12.1 μm. Further, the powder X-ray diffraction spectrum using a Cu—Kα-ray of this positive electrode powder was analogous to a rhombohedral system (R-3m). In the same manner as in Example 1, the breaking strength of the particles was obtained and found to be 135 MPa. Further, the remaining alkali amount of this positive electrode powder was obtained in the same manner as in Example 1 and found to be 0.16 wt %.

Using this positive electrode powder, a positive electrode sheet was prepared in the same manner as in Example 1. The electrode layer density of the obtained positive electrode sheet was 3.08 g/cc. Using this positive electrode sheet as a positive electrode, a simple sealed cell made of stainless steel was assembled, and the charge and discharge performance was evaluated, in the same manner as in Example 1. As a result, the initial weight discharge capacity density at 25° C. was 158 mAh/g, the initial volume discharge capacity density was 428 mAh/CC-electrode layer, and the capacity retention after 30 times of charge and discharge cycle was 96.1%.

### Example 4

Using the nickel-cobalt-manganese composite oxyhydroxide (Ni/Co/Mn atomic ratio: 1/1/1) prepared in Example 1, a lithium carbonate powder, a zirconium oxide powder and a lithium fluoride powder were mixed to the composite oxyhydroxide powder, and the mixture was fired, followed by mixing and pulverization in the same manner as in Example 1, to obtain a Li(Ni_{1/3}Co_{1/3}Mn_{1/3})_{0.995}Zr_{0.005}O_{1.99}F_{0.01} powder. This positive electrode power had a specific surface area of 0.55 m²/g by a nitrogen adsorption method and a volume average particle size D50 of 11.4 μm. Further, the powder X-ray diffraction spectrum using a Cu—Kα-ray of this positive electrode powder was analogous to a rhombohedral system (R-3m). In the same manner as in Example 1, the breaking strength of the particles was obtained and found to be 150 MPa. Further, the remaining alkali amount of this positive electrode powder was obtained in the same manner as in Example 1 and found to be 0.12 wt %.

Using this positive electrode powder, a positive electrode sheet was prepared in the same manner as in Example 1. The electrode layer density of the obtained positive electrode sheet was 3.11 g/cc. Using this positive electrode sheet as a positive electrode, a simple sealed cell made of stainless steel was assembled, and the charge and discharge performance was evaluated, in the same manner as in Example 1. As a result, the initial weight discharge capacity density at 25° C. was 162 mAh/g, the initial volume discharge capacity density was 435 mAh/CC-electrode layer, and the capacity retention after 30 times of charge and discharge cycle was 98.0%.

### Example 5

A nickel-cobalt-manganese composite oxyhydroxide (Ni/Co/Mn atomic ratio: 1/1/1) was obtained in the same manner as in Example 1 except that the oxygen concentration in the coprecipitation solution was lowered, the stirring rate was increased and the slurry concentration was increased. The particle size distribution of this composite oxide was measured by a laser scattering method. As a result, the volume average particle size D50 was 2.6 μm.

The obtained nickel-cobalt-manganese composite oxyhydroxide and a lithium carbonate powder were mixed, and the mixture was fired, followed by mixing and pulverization in the same manner as in Example 1 to obtain a LiNi_{1/3}Co_{1/3}Mn_{1/3}O₂ powder. Further, this positive electrode power had a specific surface area of 0.83 m²/g by a nitrogen adsorption method and a volume average particle size D50 of 3.1 μm. Further, the powder X-ray diffraction spectrum using a Cu—Kα-ray was analogous to a rhombohedral system (R-3m). In the same manner as in Example 1, the breaking strength of the particles was obtained and found to be 135 MPa. Further, the remaining alkali amount of this positive electrode powder was obtained in the same manner as in Example 1 and found to be 0.15 wt %.

Using a positive electrode mixed powder obtained by mixing 20 parts by weight of this positive electrode powder having a small size with 80 parts by weight of the positive electrode powder having a large size with an average particle size of 11.5 μm, prepared in Example 1, a positive electrode sheet was prepared in the same manner as in Example 1. The ratio of the average particle size D50 of the small size to the average particle size D50 of the large size, was 1/3.7. The electrode layer density of the obtained positive electrode sheet was 3.24 g/cc.

Using this positive electrode sheet as a positive electrode, a simple sealed cell made of stainless steel was assembled, and the charge and discharge performance was evaluated, in the same manner as in Example 1. As a result, the initial weight discharge capacity density at 25° C. was 161 mAh/g, the initial volume discharge capacity density was 458 mAh/CC-electrode layer, and the initial charge and discharge efficiency was 91.0%. Further, the capacity retention after 30 times of charge and discharge cycle was 97.3%.

### Comparative Example 1

A nickel-cobalt-manganese composite oxyhydroxide (Ni/Co/Mn atomic ratio: 1/1/1) was prepared in the same manner as in Example 1 except that the oxygen concentration in the slurry was increased, the stirring rate was decreased, and the slurry concentration was decreased. To this composite oxyhydroxide powder, lithium hydroxide monohydrate was mixed, and the mixture was fired, followed by mixing and pulverization in the same manner as in Example 1, to obtain a LiNi_{1/3}Co_{1/3}Mn_{1/3}O₂ powder. The powder had an average particle size of 13.5 μm and a specific surface area of 0.96 m²/g. The powder X-ray diffraction spectrum using a Cu—Kα-ray of this positive electrode powder was analogous to a rhombohedral system (R-3m). In the same manner as in Example 1, the breaking strength of the particles was obtained and found to be 27.2 MPa. Using this positive electrode powder, a positive electrode sheet was prepared in the same manner as in Example 1. The electrode layer density of the obtained positive electrode sheet was 2.91 g/cc. Using this positive electrode sheet as a positive electrode, a simple sealed cell made of stainless steel was assembled, and the charge and discharge performance was evaluated, in the same manner as in Example 1. As a result, the initial weight discharge capacity density at 25° C. was 156 mAh/g, the initial volume discharge capacity density was 399 mAh/CC-electrode layer, and the initial charge and discharge efficiency was 87%. Further, the capacity retention after 30 times of charge and discharge cycle was 93.2%.

### INDUSTRIAL APPLICABILITY

According to the present invention, a lithium-nickel-cobalt-manganese composite oxide powder for a positive electrode of a lithium secondary battery, which has large initial volume discharge capacity density and initial weight discharge capacity density and which also has high initial charge and discharge efficiency, charge and discharge cycle stability, and safety, a positive electrode for a lithium secondary battery containing such a lithium-nickel-cobalt-manganese composite oxide powder, and a lithium secondary battery are provided.

The entire disclosure of Japanese Patent Application No. 2003-070834 filed on Mar. 14, 2003 including specification, claims and summary is incorporated herein by reference in its entirety.

1. A lithium-nickel-cobalt-manganese composite oxide powder for a lithium secondary battery, characterized in that it is an agglomerated granular composite oxide powder having an average particle size D50 of from 3 to 15 μm, formed by agglomeration of many fine particles of lithium-nickel-cobalt-manganese composite oxide represented by the formula LiₚNiₓCo_{y}Mn_{z}M_{q}O₂₋ₐFₐ (wherein M is a transition metal element other than Ni, Co or Mn, or an alkaline earth metal element, 0.9≦p≦1.1, 0.2≦x≦0.5. 0.1≦y≦0.4, 0.2≦z≦0.5, 0≦q≦0.05, 1.9≦2-a≦2.1, x+y+z+q=1, and 0≦a≦0.02), and the compression breaking strength of the powder is at least 50 MPa.

2. The lithium-nickel-cobalt-manganese composite oxide powder according to claim 1, wherein the specific surface area of the powder is from 0.3 to 2.0 m²/g, and the shape of particles is substantially spherical.

3. The lithium-nickel-cobalt-manganese composite oxide powder according to claim 1, wherein 0.94≦x/z≦1.06, and the contained remaining alkali amount is at most 0.25 wt %.

4. The lithium-nickel-cobalt-manganese composite oxide powder according to claim 1, wherein the compression breaking strength of the powder is from 80 to 300 MPa.

5. A lithium-nickel-cobalt-manganese composite oxide powder for a lithium secondary battery, characterized in that a lithium-nickel-cobalt-manganese composite oxide powder for a lithium secondary battery having a large particle size, which is an agglomerated granular composite oxide powder having an average particle size D50 of from 3 to 15 μm, formed by agglomeration of many fine particles of a lithium-nickel-cobalt-manganese composite oxide represented by the general formula LiₚNiₓCo_{y}Mn_{z}M_{q}O₂₋ₐFₐ (wherein M is a transition metal element other than Ni, Co or Mn, or an alkaline earth metal element, and 0.9≦p≦1.1, 0.2≦x≦0.5, 0.1≦y≦0.4, 0.2≦z≦0.5, 0≦q≦0.05, 1.9≦2-a≦2.1, x+y+z+q=1, and 0≦a≦0.02) wherein the compression breaking strength of the powder is at least 50 MPa, and a lithium-nickel-cobalt-manganese composite oxide powder for a lithium secondary battery having a small particle size, having an average particle size of from ½ to ⅕ of the average particle size D50 of the large particle size, are mixed in a weight ratio of from 9:1 to 6:4.

6. The lithium-nickel-cobalt-manganese composite oxide powder for a lithium secondary battery according to claim 5, wherein the lithium-nickel-cobalt-manganese composite oxide powder for a lithium secondary battery having a large particle size, wherein the compression breaking strength of the powder is at least 50 MPa, and the lithium-nickel-cobalt-manganese composite oxide powder for a lithium secondary battery having a small particle size, having an average particle size of from ½ to ⅕ of the average particle size D50 of the large particle size, are mixed in a weight ratio of from 8.5:1.5 to 7:3.

7. The lithium-nickel-cobalt-manganese composite oxide powder for a lithium secondary battery according to claim 5, wherein the average particle size D50 formed by agglomeration of many fine particles of the lithium-nickel-cobalt-manganese composite oxide, is from 8 to 15 μm.

8. A positive electrode for a lithium secondary battery containing the lithium-nickel-cobalt-manganese composite oxide as defined in claim 1.

9. (canceled)

10. A positive electrode for a lithium secondary battery containing the lithium-nickel-cobalt-manganese composite oxide as defined in claim 5

11. A lithium secondary battery using the positive electrode as defined in claim 8.

12. A lithium secondary battery whose positive electrode is the positive electrode of claim 10.
